(19) United States
(12) Patent Application Publication
(10) Pub. No.: US 2013/0135253 A1
(43) Pub. Date: May 30, 2013

(54) OPTICAL TOUCH DEVICE

(71) Applicants: JUI-HSIANG LO, New Taipei (TW); Chi-ming Tseng, New Taipei (TW)

(72) Inventors: JUI-HSIANG LO, New Taipei (TW); Chi-ming Tseng, New Taipei (TW)

(73) Assignee: Cheng Uei Precision Industry Co., LTD., New Taipei City (TW)

(21) Appl. No.: 13/304,391

(22) Filed: Nov. 24, 2011

(51) Int. Cl. G06F 3/042

(52) U.S. Cl. 345/175; 178/18.09

(57) ABSTRACT

Disclosed is an optical touch device, which includes: a substrate defining a touch area, a chamfer formed on at least one corner of the substrate; at least one sensing component disposed on a side of the chamfer of the substrate, the sensing component comprising a sensing element and a luminous element; at least one first reflective element disposed around the touch area for reflecting a light emitted from the luminous element to the touch area; at least one second reflective element disposed above the sensing element for guiding the light reflected from the first reflective element into the sensing element. The optical touch device of the present invention has a simple structure and a compact size.

### FIELD OF THE INVENTION

The present invention relates to a touch device, and especially to an optical touch device.

### BACKGROUND OF THE INVENTION

A touch screen can be operated directly by a touch of objects or fingers, so it replaces a mechanical push-button operation. Optical touch technologies used in the touch screen are widely used, and they employ a concept of receiving and breaking of a light beam. When the light beam is interrupted, a position of the breaking can be detected for determining its exact position.

As shown in FIG. 1 to FIG. 3, a conventional optical touch device 500 includes a glass substrate 501, infrared generators 502 disposed on glass substrate 501, reflective strips 503, and sensors 504 for sensing infrared. The sensors 504 herein are placed on the corners of the glass substrate 501, and the infrared generator 502 are placed above the sensors 504. Generally, the number of the reflective strips 503 is at least two, and the reflective strips 503 are respectively disposed on a left periphery and a lower periphery of the glass substrate 501. Light beams are emitted from the infrared generator 502 and reflected by the reflective strips 503, thereby forming a touch area 505. When a finger or other object touches the touch area 505 to break the light beam, the sensor 504 detects a position of the finger or the object relative to the touch area 505, thus completing the operation.

However, with a growing consumer demand for compact size of electronic products, the size of the conventional optical touch device 500 can not meet the consumer demand.

Referring to FIG. 2 again, the sensor 504 is directly disposed on the glass substrate 501, and the infrared generator 502 is directly disposed on the sensor 504, it makes the overall height/thickness of the optical touch device 500 increase, and impede the competitiveness of the products.

### SUMMARY OF THE INVENTION

An objective of the present invention is to provide an optical touch device with a simple structure and a compact size in accordance with the drawback of the above-mentioned prior art.

To achieve the foregoing objective, the optical touch device provided by the present invention includes: a substrate defining a touch area, a chamfer formed on at least one corner of the substrate; at least one sensing component disposed on a side of the chamfer of the substrate, the sensing component comprising a sensing element and a luminous element; at least one first reflective element disposed around the touch area for reflecting a light emitted from the luminous element to the touch area; at least one second reflective element disposed above the sensing element for guiding the light reflected from the first reflective element into the sensing element.

As mentioned above, according to the chamfer formed in the corner of the substrate in the optical touch device 1 of the present invention, the sensing component including the luminous element and the sensing element can be disposed on the side of the chamfer, so that a overall height of the optical touch device will not increase due to the sensing component. Therefore, the optical touch device of the present invention is compact and lightweight, and it can adapt to the compact size of development demand for the electronic products.

### BRIEF DESCRIPTION OF THE DRAWINGS

FIG. 1 is a top view illustrating a conventional optical touch device;

FIG. 2 is a cross-sectional view illustrating the optical touch device in FIG. 1;

FIG. 3 is a schematic drawing illustrating an operation of a user's finger on the optical touch device in FIG. 2;

FIG. 4 is a top view illustrating an optical touch device of the present invention;

FIG. 5 is a cross-sectional view illustrating the optical touch device in FIG. 4;

FIG. 6 is a local zoom drawing illustrating A portion of FIG. 5; and

FIG. 7 is a schematic drawing illustrating an operation of a user's finger on the optical touch device.

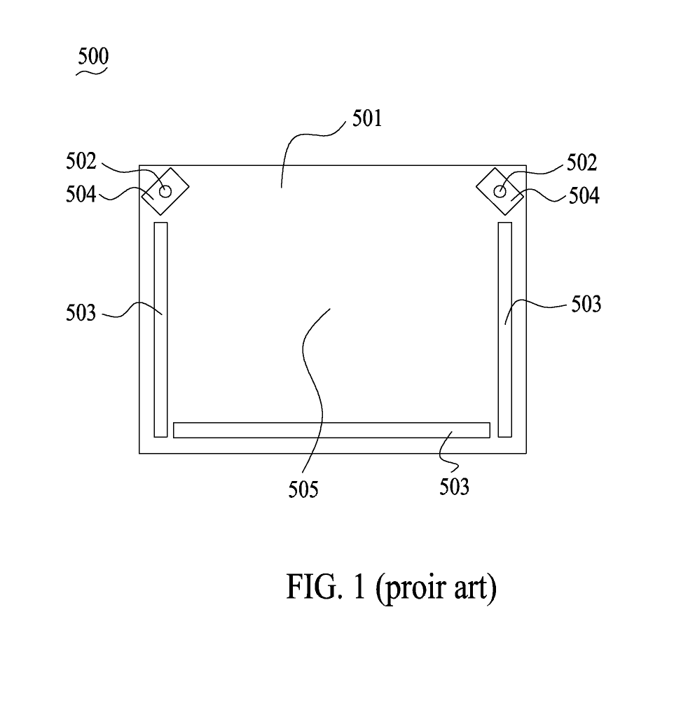

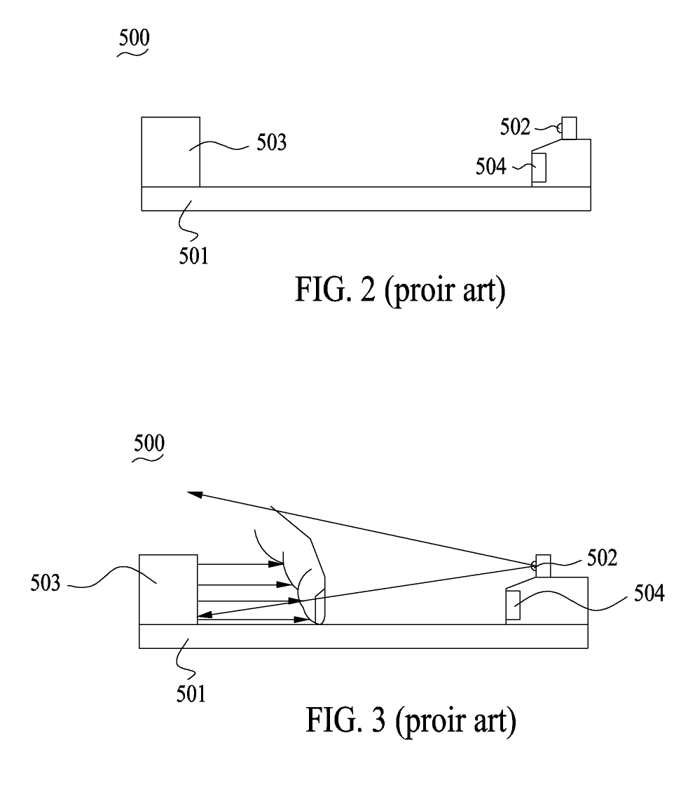

### DETAILED DESCRIPTION OF THE PREFERRED EMBODIMENTS

Reference will now be made in detail to the present preferred embodiment of the invention, example of which is illustrated in the accompanying drawings.

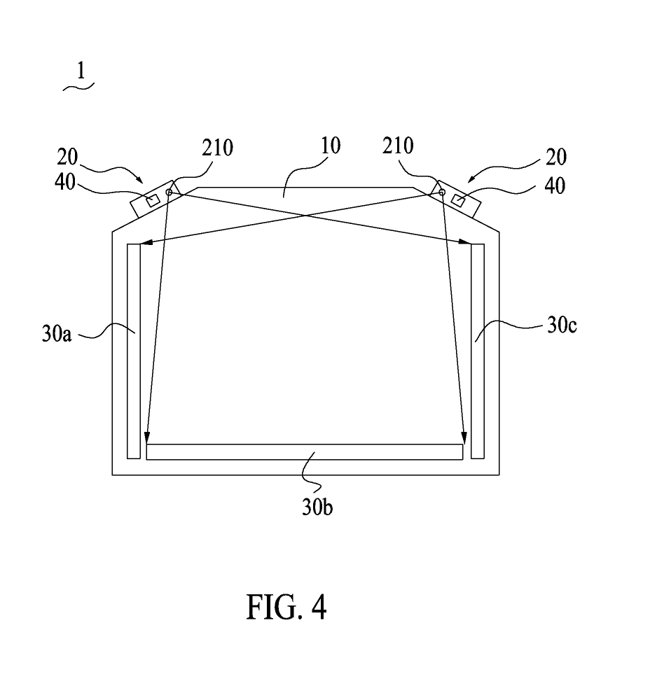

Referring to FIG. 4, the optical touch device 1 of the present invention includes a substrate 10, sensing components 20 which include a luminous element 210 and a sensing element 220, first reflective elements 30a, 30b, and 30c which are utilized to guide light emitted from the luminous element 210, and second reflective elements 40 which are utilized to reflect the light into the sensing components 20.

Specifically, the substrate 10 is made of glass, and it has a predetermined thickness. The substrate 10 defines a touch area. Two chamfers are respectively formed in two corners of the substrate 10. The chamfers have an angle of 30° to 60°, and the angle of the chamfers is 45° in the embodiment. The two sensing components 20 are respectively fixed on the sides of the two chamfers. Each sensing component 20 includes the luminous element 210 and the sensing element 220 both disposed side by side. The luminous element 210 is an infrared LED (Light Emitting Diode) in the embodiment, and the sensing element 220 is utilized to detect the emitted infrared when a finger or an object touches the touch area. In order to ensure adequately effective space for the touch, the elongated first reflective elements 30a, 30b, and 30c are respectively disposed on a left side, a right side, and a lower side of the substrate 10. Specifically, the three first reflective elements 30a to 30c are directly disposed on the substrate 10, in which the first reflective element 30b is perpendicular to the other two first reflective elements 30a and 30c.

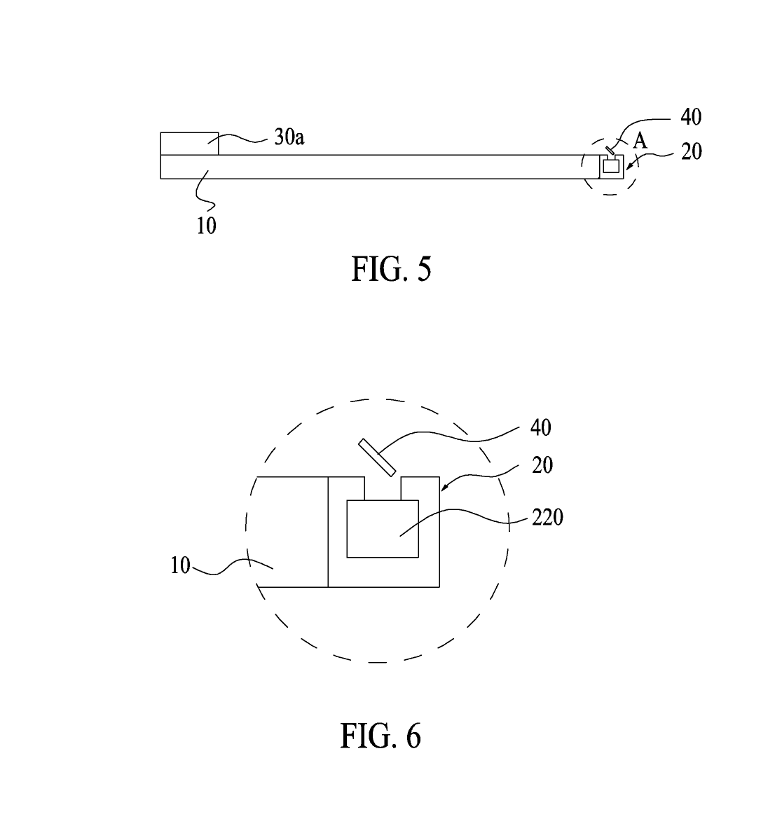

As mentioned above, each sensing component 20 includes the luminous element 210 and the sensing element 220. Specifically, as shown in FIG. 4 to FIG. 6, top surfaces of a body of the sensing component 20 and the substrate 10 are located in an identical plane, that is, a thickness of the body of the sensing component 20 is the same to a thickness of the substrate 10. Thus, a height of the overall device doesn't increase after the sensing components 20 are fixed on the sides of the chamfers of the substrate 10. The light emitted from the luminous element 210 located at the left chamfer can cover the right and lower first reflective elements 30b and 30c; and the light emitted from the luminous element 210 located at the right chamfer can cover the left and lower first reflective elements 30a and 30b.

The second reflective elements 40, which are obliquely disposed above the sensing element 220, are utilized to guide the light reflected from the first reflective elements 30a to 30c into the sensing elements 220. Preferably, in order to ensure that the light can accurately reach the sensing elements 220, the second reflective element 40 has an oblique angle of 30° to 60°. In the embodiment, an oblique angle of the second reflective element 40 is 45°.

After the luminous elements 210 emit the light to the touch area, the light are projected to the corresponding first reflective elements 30a to 30c via the touch area and then reflected to the second reflective elements 40. After the second reflective elements 40 receive the light reflected from the first reflective elements 30a to 30c, the light is reflected into the sensing elements 220, whereby the sensing element 220 receive the light.

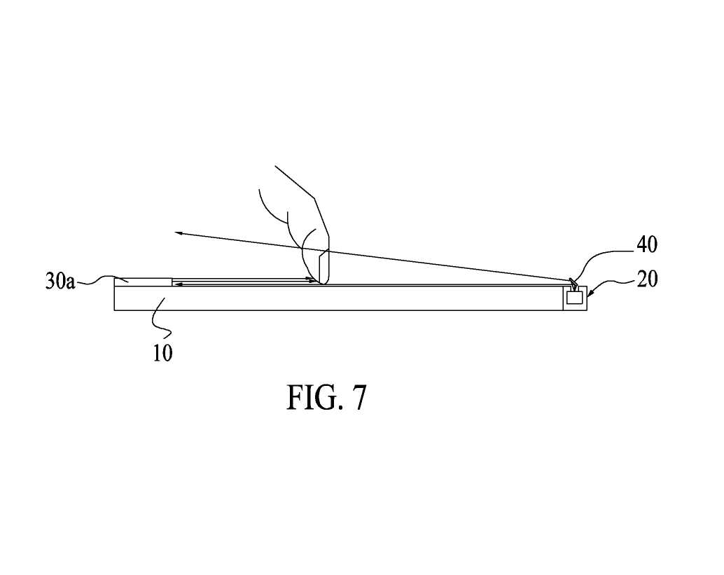

As shown in FIG. 7, when a finger or other object touches the touch area, the light reflected from the first reflective elements 30a to 30c is partially interrupted. Meanwhile, the position of the finger or the object relative to the touch area is detected by the sensing elements 220 due to the partially light being interrupted, and then an external controller connected to the optical touch device 1 completes the operation.

In summary, according to the chamfer formed in the corner of the substrate 10 in the optical touch device 1 of the present invention, the sensing component 20 including the luminous element 210 and the sensing element 220 can be disposed on the side of the chamfer, so that a overall height of the optical touch device 1 will increase due to the sensing component 20. Therefore, the optical touch device of the present invention is compact and lightweight, and it can adapt to the compact size of development demand for the electronic products.

What is claimed is:

1. An optical touch device, comprising
a substrate defining a touch area, a chamfer formed in at least one corner of the substrate;
at least one sensing component disposed on a side of the chamfer of the substrate, the sensing component comprising a sensing element and a luminous element;
at least one first reflective element disposed around the touch area for reflecting a light emitted from the luminous element to the touch area; and
at least one second reflective element disposed above the sensing element for guiding the light reflected from the first reflective element into the sensing element.

2. The optical touch device of claim 1, wherein the number of the at least one sensing component is two, and the two sensing component are respectively disposed at two adjacent corners of the substrate.

3. The optical touch device of claim 1, wherein the number of the at least one first reflective element is three, and one of the three first reflective elements is perpendicular to the other two first reflective elements.

4. The optical touch device of claim 1, wherein top surfaces of the sensing component and the substrate are located in an identical plane.

5. The optical touch device of claim 1, wherein the sensing element and the luminous element are disposed side by side, and the second reflective element is obliquely disposed above the sensing element.

6. The optical touch device of claim 1, wherein the luminous element is an infrared LED (Light Emitting Diode).

7. The optical touch device of claim 1, wherein the chamfer has an angle of 30° to 60°.

8. The optical touch device of claim 1, wherein the second reflective element has an oblique angle of 30° to 60°.
